(19) United States
(12) Patent Application Publication
(10) Pub. No.: US 2006/0059062 A1
(43) Pub. Date: Mar. 16, 2006

(54) System and method for determining optimal sourcing for aggregate goods and services

(75) Inventors: Daniel James Wood, Los Angeles, CA (US); Tamim Mourad, Los Angeles, CA (US); Omar Mourad, Los Angeles, CA (US); Cory Rosenberg, Los Angeles, CA (US)

Correspondence Address: INTELLECTUAL PROPERTY LAW OFFICE OF JOEL VOELZKE, 400 CORPORATE POINTE, SUITE 300, CULVER CITY, CA, 90230, US

(73) Assignee: PriceGrabber.com, LLC

(21) Appl. No.: 11/021,673

(22) Filed: Dec. 24, 2004

Related U.S. Application Data
(60) Provisional application No. 60/610,004, filed on Sep. 15, 2004.
(60) Provisional application No. 60/616,763, filed on Oct. 6, 2004.

(51) Int. Cl. G06Q 40/00

(52) U.S. Cl. 705/35

(57) ABSTRACT

A method of allowing shoppers to compare prices from different vendors includes receiving a shopping list of goods and/or services from the user. The best available price for each item or service on the shopping list is determined, and is displayed to the user. A best available aggregate price for the items as a group is found from a merchant who offers all of the items or services for sale, and the aggregate price is displayed for the user. The user can directly see price differences between purchasing the items individually versus purchasing the items in aggregate from a single merchant. A system for allowing a user to compare purchasing options include an input section which allows a user to specify a list of items for possible purchase. A processing section is provided for determining best available individual prices for the items if purchased separately from different merchants, and for determining a single aggregate price if the items are purchased together from a single merchant. A first display section is provided for displaying the best available individual prices, and a second display section is provided for displaying the single aggregate price.

### CROSS-REFERENCE TO RELATED APPLICATIONS

This application claims priority from U.S. Patent Provisional Application Nos. 60/610,004 and 60/616,763, which were filed on Sep. 15, 2004 and Oct. 6, 2004, respectively, and which were both entitled “System and Method for Determining Optimal Sourcing for Aggregate Goods and Services,” and which are both incorporated by reference in their entirety.

### BACKGROUND OF THE INVENTION

1. Field of the Invention

This invention relates to a system and method for determining optimal sourcing for aggregate goods and services. More particularly, in one embodiment, this invention relates to a system and method that allows a user to determine whether it is more cost-efficient to purchase a shopping list of products and/or services from a single vendor or from multiple vendors.

2. Description of Related Art

Traditionally, one who wished to purchase several different products or services had different purchasing options. One option was to purchase all of the products or services from a single source. So, for example, a clerk in an office who wished to order a variety of office supplies and equipment might place a single order with a single supplier for all of the supplies and equipment. This approach was simple and quick, but rarely did one source offer the best price in the market on each of the supplies and equipment.

Alternatively, the clerk could price the supplies and equipment at a few different suppliers, then make multiple orders to take advantage of price differences among suppliers. However, this approach was often time consuming. The clerk would need to contact various suppliers for price quotes, and might then need to wait for hours or days for the quotes to come back. Also, the clerk typically knew of only a small number of suppliers at which to price the supplies and equipment. Consequently, the clerk could spend considerable time and effort deciding whether to purchase from a single source or from multiple sources but, in the end, still not get the best possible deal.

Recently, some online vendors such as Amazon (www.amazon.com) have provided a service in which a user selects a particular product. In response, Amazon provides the Amazon price for the item, but also lists prices from other vendors for new and used versions of the same product. Consequently, a shopper may purchase the product from Amazon or, if Amazon indicates that a lower price is available from another source, purchase the item from the other source. However, although the Amazon service is useful for the user who is shopping for a single product, Amazon does not permit the user to input a shopping list of different products and receive information on whether it is more efficient to purchase the products from a single source or from multiple sources.

### SUMMARY OF THE INVENTION

The present invention provides a unique system and method for determining optimal sourcing for aggregate goods and services.

In one embodiment, a system for allowing a user to compare purchasing options includes an input section which allows a user to specify a list of items for possible purchase. The system also includes a processing section for determining the best available individual prices for the items if purchased separately from different merchants, and for determining a single aggregate price if the items are purchased together from a single merchant. The system may include a first display section for displaying the best available individual prices, and a second display section for displaying the single aggregate price.

Particular embodiments of the system may include specific features. For example, the prices may include shipping and/or taxes. The best available individual prices and the single aggregate price may be optionally displayed on a single Web page. The processing section may further determine a plurality of best available aggregate prices from a respective plurality of merchants, and the second display section may display the plurality of best available aggregate prices and associated merchants.

As further alternatives, the first and second display sections may be presented to a user on a single Web page. The user may add items listed within the second display section to a virtual shopping cart by selecting each item. The selection of the item causes a new browser window to open, displaying a page from the single merchant's web site. The user adds each item to a shopping cart by performing a single click at said single merchant's web page.

In one embodiment, the first and second display sections are presented to a user on a single Web page. The user can add items listed within the second display section to a virtual shopping cart by selecting all items at once and adding them as a group to the shopping cart by performing a single click.

Another embodiment is a method of allowing shoppers to compare prices from different vendors. The method includes receiving from the user a list of items selected that define a shopping list. The best available individual prices for the items are determined from a variety of merchants. The best available individual prices for the items and the merchants associated, respectively, with those individual prices are displayed, along with a total of those individual prices. At least one best available aggregate price for the items as a group is determined from at least a first merchant who offers all of the items for sale. At least one aggregate price is displayed for the user, although multiple aggregate merchants and corresponding multiple aggregate prices may be displayed. The display allows the user to directly see price differences between purchasing the items individually versus purchasing the items from the aggregate merchant or merchants. The user can thus easily decide whether he wishes to purchase the items individually from the different merchants or as a group from a common merchant.

The method may include other features. The identities of the merchants may be displayed, along with the associated best available prices. The identity of the first aggregate merchant along with the aggregate price may also be displayed. The method may further comprise means for highlighting the lower of the individual price total and the best available aggregate price, whereby a user receives a visual indicator of the best possible overall price for the list of items.

Exemplary embodiments of the invention will be further described below with reference to the drawings, in which like numbers refer to like parts.

### BRIEF DESCRIPTION OF THE DRAWINGS

According to one illustrative embodiment:

FIG. 1 is a simplified screen shot of a home page from which a user may select or search for a category of products or services from which to shop;

FIG. 2 is a simplified screen shot of a the “Computers” page as selected from the home page, in which computer-related goods and services are displayed;

FIG. 3 is a simplified screen shot of a products page in which a variety of 23 inch computer monitors are displayed, along with the number of vendors selling each of the search results;

FIG. 4 is a simplified screen shot of search results for a particular computer monitor;

FIG. 5 is a simplified screen shot of a product page for the computer monitor of FIG. 4 from a particular vendor;

FIG. 6 is a simplified screen shot of an optional account log in screen;

FIG. 7 is a simplified screen shot of a shopping list after a particular computer monitor has been added to the shopping list;

FIG. 8 is a simplified screen shot of a shopping list after three products have been added to the list;

FIG. 9 is a simplified screen-shot of the shopping list from a single source supplier of all three products, showing the price for each individual item, as well as the total if all three items are purchased from the single source;

FIG. 10 is a flow chart of a method in accordance with one aspect of an embodiment of the invention; and

FIG. 11 is a flow chart of a method in accordance with another aspect of an embodiment of the invention.

### DETAILED DESCRIPTION OF THE PREFERRED EMBODIMENTS

The invention will be described below with reference to illustrative embodiments in which a consumer seeks to determine whether purchasing a variety of items or services will cost less if purchased from a single source, or from multiple sources. It is to be understood that the preferred embodiment is for illustration purposes only and does not limit the invention. Throughout the discussion, the terms “consumer,” “potential purchaser,” “user,” or “shopper” will be used to refer to the person who is seeking quotes for an article or articles. The term “price” will be used even though it may be understood that the price may be expressed either in absolute dollars or other monetary units, or relatively compared to manufacturer's suggested retail price (MSRP) or dealer invoice price. The terms “quote,” “selling bid,” “bid,” or “offering price” will refer to a quote by a potential seller of an article. The term “vendor,” “potential seller,” or “dealer” will refer to the potential seller who provides a quote to the system for the consumer's consideration. The term “person” will be used in its legal sense to refer to any individual, business entity, government entity, or the like. The term “item” may refer to either a good or a service, or to something else that a user may wish to purchase online.

I. Adding Items to the Shopping List

According to one embodiment suited for on line shopping for consumer goods, consumers begin by visiting a single on line shopping site which is affiliated with multiple vendors. Such sites are sometimes referred to as shopping bots. The consumer specifies, reviews, and selects individual items at the shopping site that he wishes to purchase, and adds those items one by one to a virtual shopping list. For each page displaying and/or describing an item with which the user is satisfied and wishes to purchase, the consumer selects an “Add to Shopping List” command. This adds the item selected to a virtual shopping list.

II. Shopping List

Each time the user adds a product to his shopping list, the shopping list page is displayed. Alternatively, from other pages the consumer can click on a link entitled “Your Shopping List” to view the contents of the shopping list. The shopping list page is comprised of two sections: “Products” and “Price Comparison.” The latter section contains two sub-sections, namely “Buy Products from Separate Merchants” and “Make Life Easier and Buy All Your Products from ONE Merchant”. Each of these will be discussed, in turn.

A. Products Section

The Products section allows the user to remove products from his shopping list, as well as to ignore certain product conditions, namely: refurbished, out of stock, generic, used or OEM. In addition, the user may click on a product and visit the product page for further information regarding that particular product.

B. Price Comparison Section

1. “Buy Products From Separate Merchants” Subsection

The first Price Comparison subsection, namely “Buy Products from Separate Merchants”, allows the user to see the best BottomLinePrice for each individual product. The user has the option of visiting the retailer site, changing the retailer, and changing the BottomLine zip code. Within this section, the merchant review rating, retailer price, shipping cost, tax and total BottomLinePrice are shown, including the grand total of the combined orders.

2. “Buy All Your Products from ONE Merchant” Subsection

The second Price Comparison subsection, namely “Make Life Easier and Buy All Your Products from ONE Merchant,” shows those merchants that sell all of the products in the shopping list. For each merchant, the user can click on a link to visit the retailer, view the ratings for the retailer and see the pricing data (price, shipping, sales tax) as well as the total price+tax. In addition, an approximated shipping cost is also presented.

The simplest reason that a shopper may wish to purchase all of the items from the same retailer derives from the fact that different retailers have different shipping and handling charge schedules depending upon the total weight or total purchase price and the zip code to which the items are being shipped. Thus, the cost for shipping the items together might be less than the sum of the charges for shipping the items individually. Once this difference in shipping and handling charges is accounted for, purchasing the items from a single vendor might be the most economical. There are other reasons that a consumer might wish to purchase all of the items, or certain subsets of the items, from a single retailer, even if doing so is slightly more expensive than purchasing the items individually. Those reasons include: convenience of ordering, accounting, and order tracking; a desire to have a single vendor be responsible and provide support if the items do not operate properly together; an already established account including possibly a preferred buyer discount with a particular vendor; a particular vendor's reputation or history of providing quality service; all items being currently in stock and ready to ship from a single retailer; and many other objective and subjective factors. To the extent that those factors are objective or at least quantifiable, those factors can also be displayed on the Shopping List page. For example, the Shopping List page can display the expected shipping time for the items, the number of stars received by the retailer for consumer satisfaction, etc. The display of those factors next to each vendor or item as applicable can help the consumer make his decision as to which vendor(s) from whom to order.

The invention will now be illustrated with reference to screen shots as seen by the consumer in one embodiment.

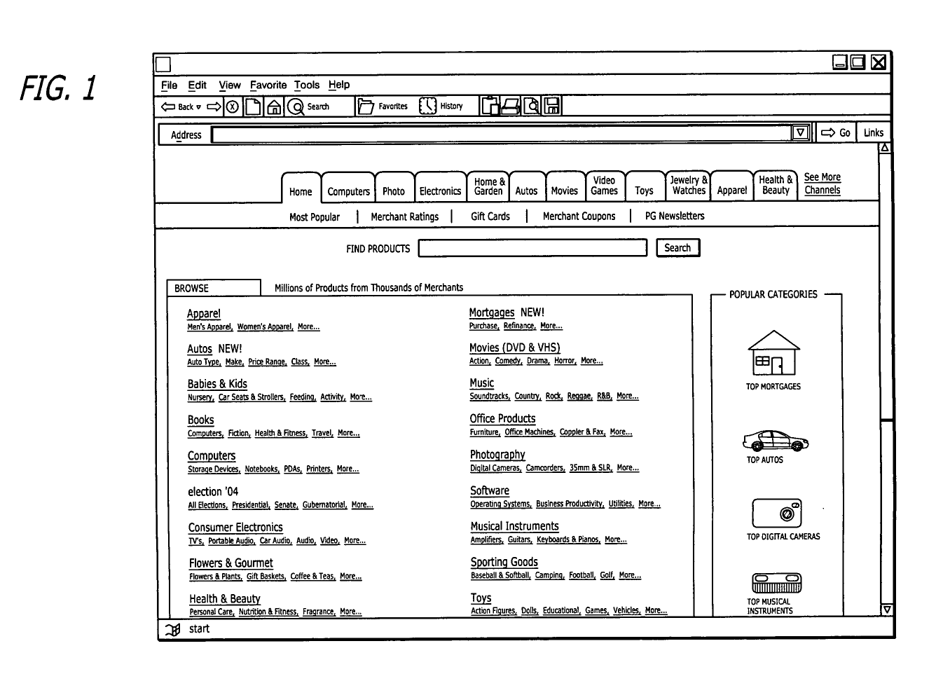

FIG. 1 is a simplified screen shot of a home page from which a user may select or search for a category of products or services from which to shop. In the example of FIG. 1, the user may select from a wide variety of goods and services, such as apparel, automobiles, books, and so on. The home page may have various other features, such as a listing of the most popular items, tabs on which the user may click with a mouse to go to a particular product or service category, and/or other features.

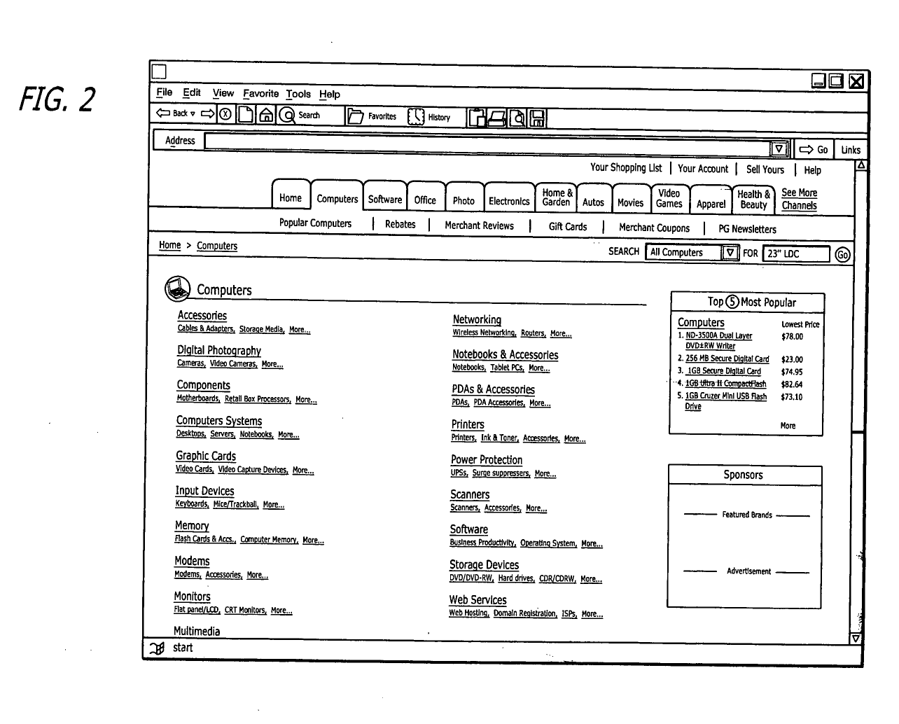

FIG. 2 is a simplified screen shot of the “Computers” product page as selected from the home page, in which computer-related goods and services are displayed. The “Computers” page displays many categories of computer-related products, such as accessories, scanners, software, and the like. Subcategories within each group may also be displayed. In the example of FIG. 2, the most popular computer products and the lowest price at which each product is available is displayed. The screen also provides search means into which a user may type search terms, such as “23” LCD “to search for a 23” LCD computer monitor. The user may limit the search to a particular category or subcategory of goods or services.

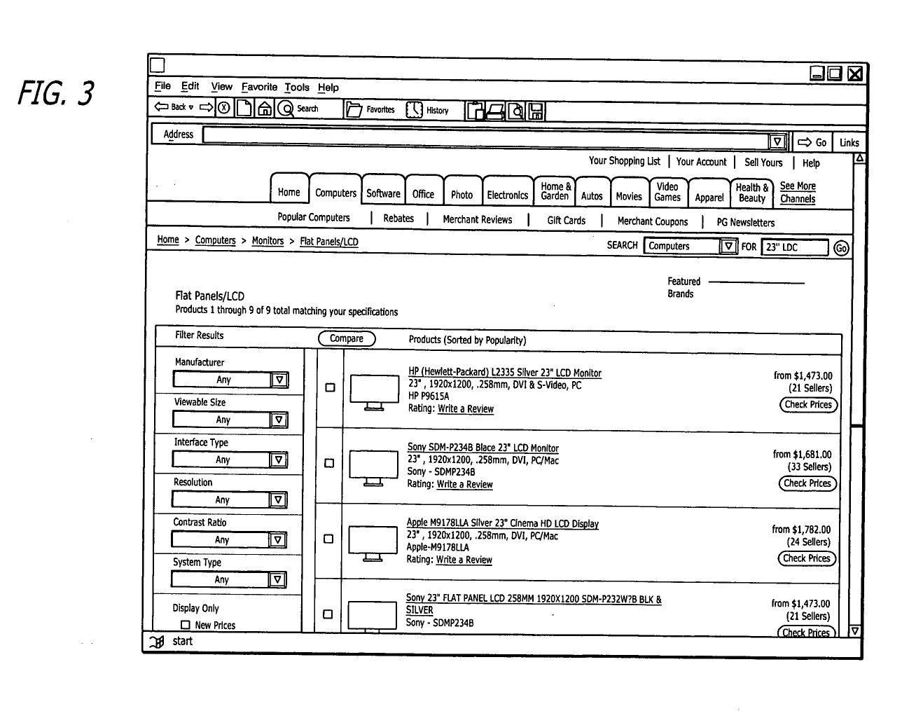

FIG. 3 is a simplified screen shot of a products page in which a variety of 23″ LCD computer monitors are displayed, along with a number of vendors selling the monitors. The results may be listed by any of a number of criteria, including popularity, rating, high price first, or low price first. The results may be further filtered by any of a variety of different criteria, such as manufacturer, viewable size, interface type, resolution, contrast ratio, system type, or any other suitable criteria. In the example of FIG. 3, these choices are provided by way of scroll-down menu. The filter criteria will change depending on the particular product that has been searched. So, for example, the user would be presented with an entirely different set of filter criteria from which to choose if he or she had searched for a particular type of computer printer.

In the example of FIG. 3, the user also has the opportunity to select particular computer monitors to compare. The user clicks on boxes adjacent to products in which he or she is interested, and then clicks on the “Compare” button. In response, the system displays a comparison of characteristics of the screens that the user has checked. In one embodiment, the system displays a side-by-side comparison of the manufacturer name, general description, lowest price, user rating, whether or not rebates are available for each monitor, and various specifications of each monitor. The user is thereby able to conveniently compare monitors of interest.

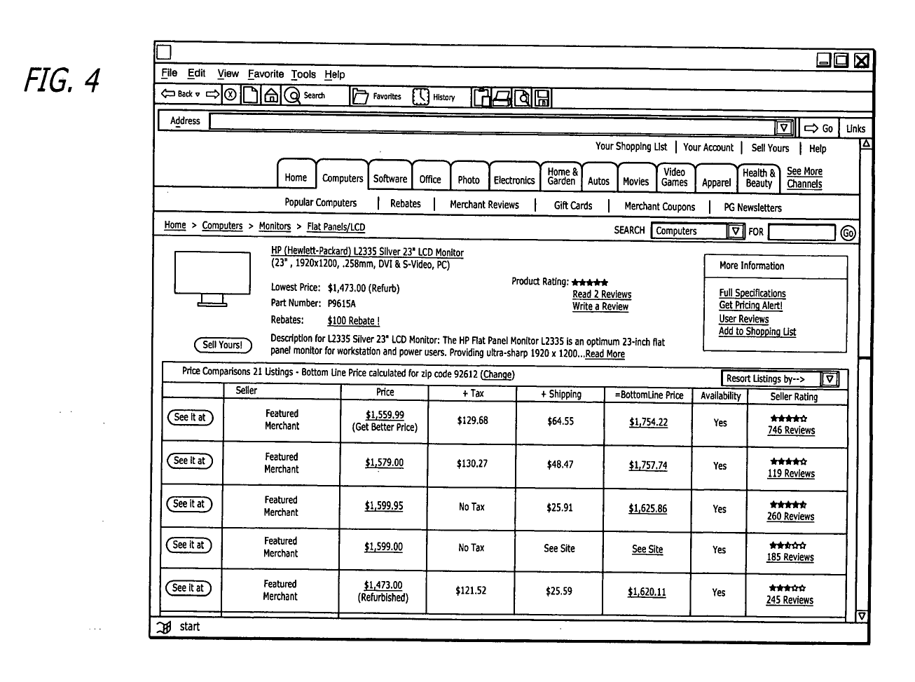

FIG. 4 is an example of a screen that may be displayed when the user clicks on a particular product name in FIG. 3. The screen of FIG. 4 lists a variety of different merchants that sell that particular monitor (which, in this case, is an HP L2335 Silver 23″ LCD Monitor). The screen also includes the price, tax, shipping charge, bottom line price, availability and “Seller Rating” corresponding to each merchant. The “Seller Rating” may be based upon ratings by users of the website who have submitted ratings of a particular merchant.

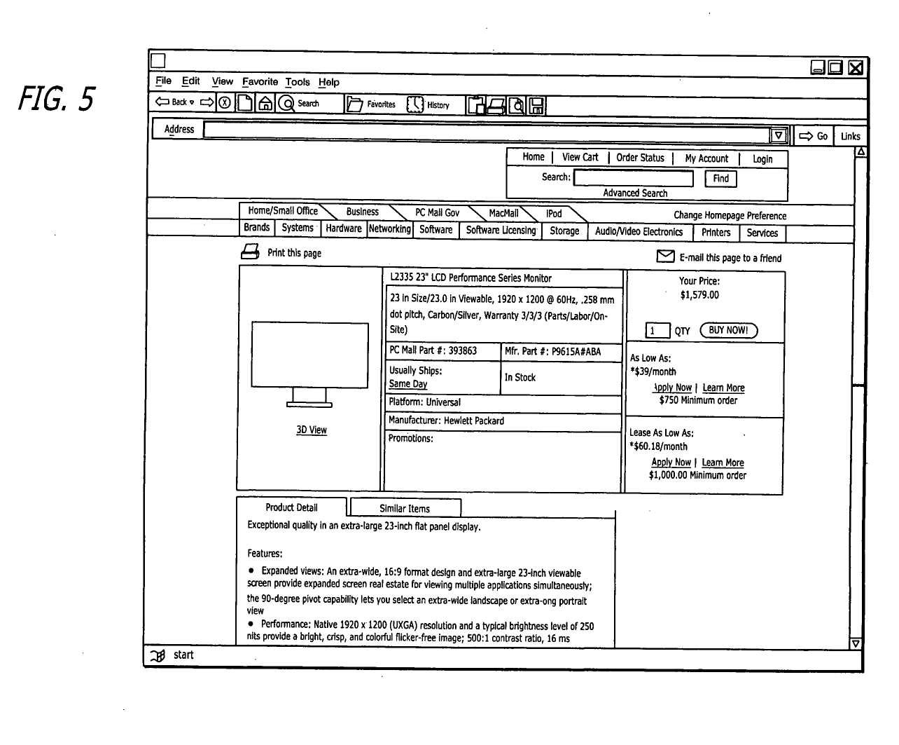

The system also permits the user to click on a “See It At” button adjacent to the name of a particular merchant in order to go to the website of that merchant for more information on ordering the product, if desired. FIG. 5, for example, illustrates the product page for the L2335 monitor as displayed at the “PC Mall” website. The user has reached FIG. 5 by clicking on the “See It At” button on FIG. 4, adjacent to the “PC Mall” logo. The user is then able to gather further information about the item and/or purchase the item in the usual manner on the site.

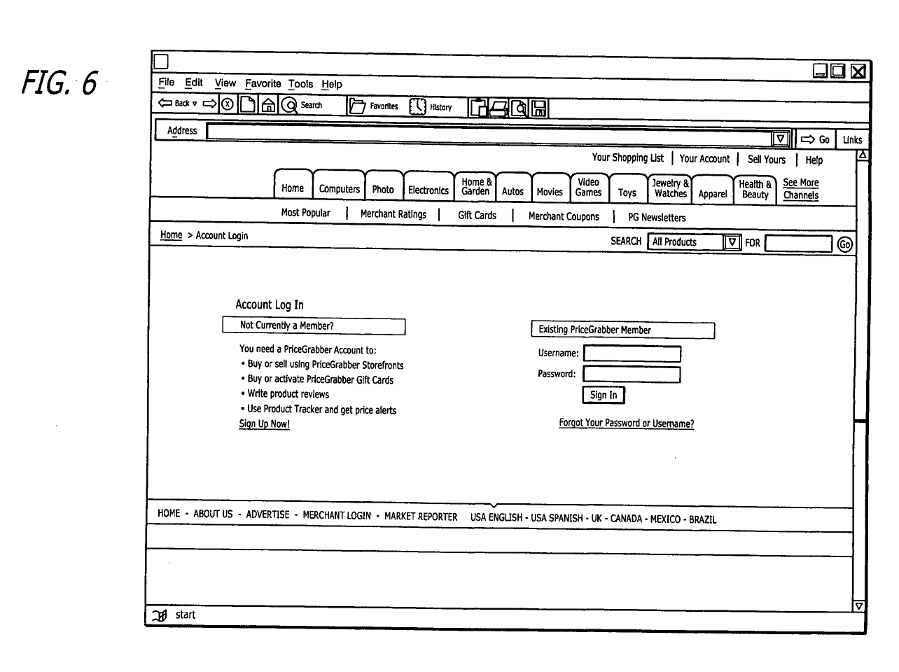

Returning to FIG. 4, if the user decides to purchase the monitor, he or she may click on “Add to Shopping List,” thereby adding the item to a list of items that the system maintains for the user. Prior to establishing a “Shopping List,” however, the system may require the user to enter a username and password—or to set-up a username and password—as illustrated in FIG. 6. This enables the system to correlate the shopping list with a particular user of the system. Information about particular users, such as their e-mail address and other information, may be stored on the system and correlated with a particular user name and password.

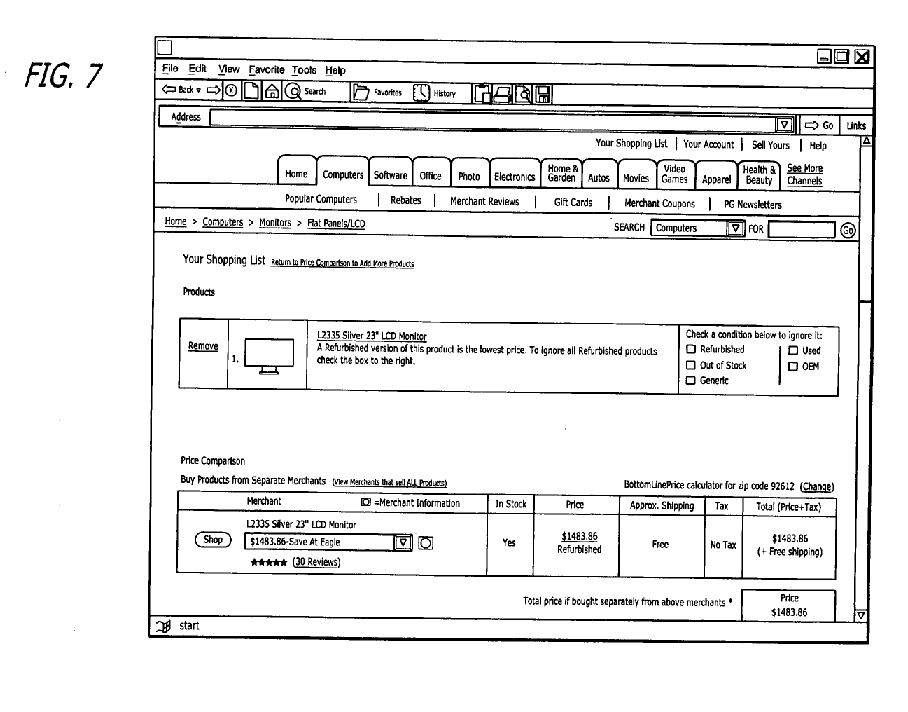

As the user browses through the website, he or she may add items or services to the shopping list. FIG. 7 illustrates an example of a shopping list after a single item (the L2335 monitor) has been added. The user is presented with the lowest-priced merchant for the L2335, along with a scroll-down menu from which the user may view other prices available at other merchants for the same product. The screen also displays information such as whether the item is in stock, the price at which the product is offered, the approximate shipping cost, the tax charge, and the total price of the item.

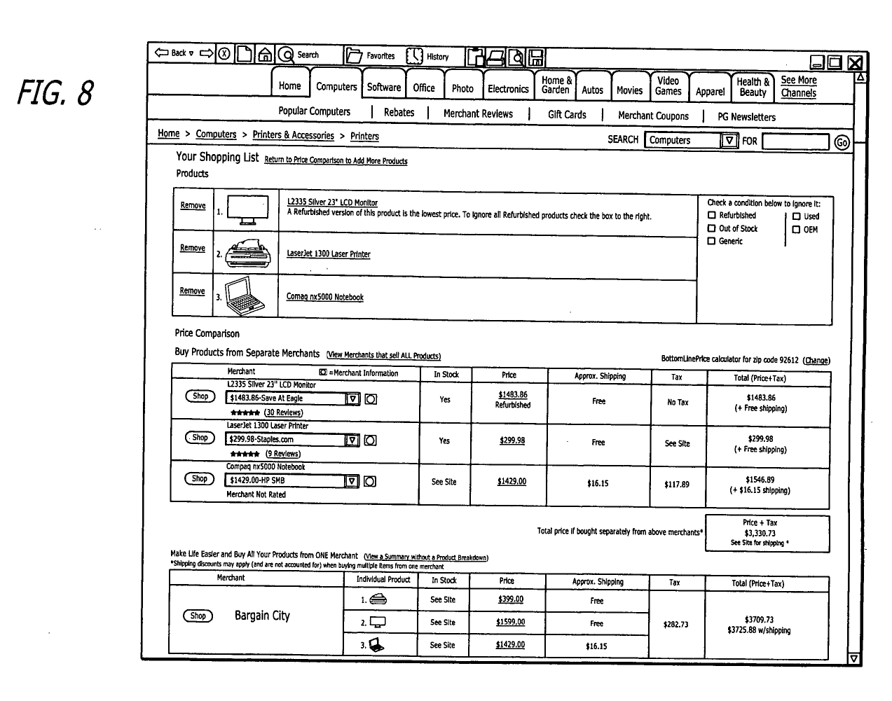

As the user continues to browse through the website, he or she may add more items to the shopping list. FIG. 8, for example, illustrates the shopping list after the user has added three items to the list: the L2335 23″ monitor, a Laserjet 1300 Laser Printer, and a Compaq nx5000 Notebook Computer. For each product, the screen displays the lowest price available for that particular product. For example, the L2335 monitor is available from “Save at Eagle” for $1483.86 in a refurbished condition, with no shipping charge and no tax. The Laserjet 1300 printer is lowest-priced at Staples.com, with a price of $299.98 with no shipping charge and an instruction to see the Staples.com web site for information on the tax charge. The Compaq notebook computer is available from “HP SMB” for a lowest price of $1429.00, with $16.15 shipping and $117.89 tax. The availability of the item from each merchant is also displayed.

Below the name of each merchant is a rating of that merchant, if available. For instance, Save At Eagle is given a rating of 5 stars based on 30 user reviews. Staples.com is also rated at 5 stars, based on 9 user reviews. No review information is available for “HP SMB.”

Below the listing of merchants and charges, the system displays a total price if the items are bought separately from the listed merchants. In this case, the total price is $3,330.73, plus an unknown tax fee for which the user must visit Staples.com.

A second, lower portion of the screen is the Make Life Easier and Buy All Your Products from ONE Merchant subsection, which presents each retailer that offers all of the products at once within the shopping list. In this case, a single merchant (Bargain City) carries all of the products. The price for each item and approximate shipping to the consumer's zip code as provided by the consumer is listed adjacent each product name. A total tax amount is displayed, as is the total price (including shipping and taxes) if the user were to purchase the three items from the single source (Bargain City). In this case, the cost to purchase the goods in aggregate from Bargain City is $3709.73, or $3725.88 w/shipping.

The user is thus able to see, on a single screen, a comparison of the cost of purchasing the items from the lowest-cost providers individually versus purchasing the items in aggregate from a single provider. In this case, the cost of purchasing the goods from separate low-cost providers is less than the cost of purchasing the goods in aggregate from a single provider. Although optional, the system may highlight the lower of the two prices—single provider vs. aggregate—so that the user can immediately see what is the best price available.

It should be noted that not all users will wish to purchase the items at the lowest possible price. There can be a convenience factor—particularly when several goods are involved—with purchasing the goods in aggregate from a single provider, even when the total price is more expensive. With the information presented on the display screen, the user can balance all of the various factors salient to him and make his purchasing decision accordingly. Although not illustrated in the figure, the system preferably displays all of the participating merchants who offer all of the products on the list. The consumer can choose from among various merchants who offer all the items on the shopping list, balancing the usual factors including total cost, merchant reputation, estimated shipping date, etc.

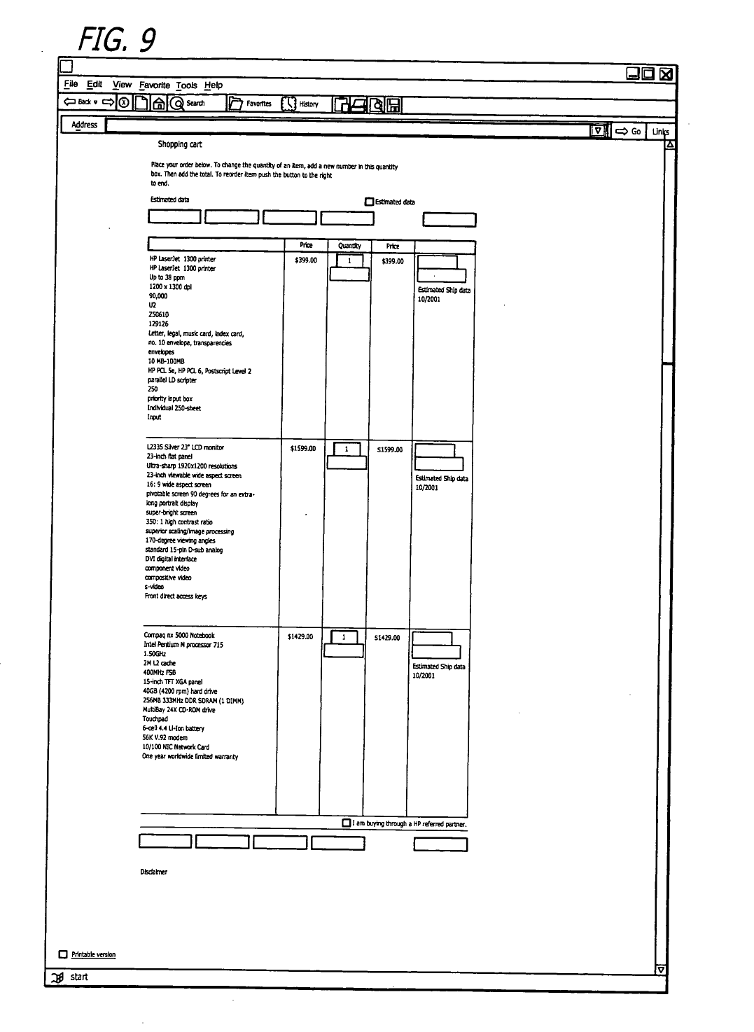

To purchase a product, the user clicks on the “Shop” button adjacent to a particular provider. For example, if the user wished to purchase the products in aggregate from Bargain City, he or she would click on the “Shop” button adjacent to the “Bargain City” logo on the screen in FIG. 8. The user would then be directed to a Bargain City website, where he or she could purchase the products in aggregate. FIG. 9 illustrates a sample screen from a Bargain City website, in which each of the three desired items is listed, and various data concerning each item is provided. The user is able to purchase the items from the website, which will typically require the user to provide billing information of some sort, such as a credit card number.

Alternatively, the user could purchase any of the products individually by clicking on the “Shop” button adjacent to the pull-down menus associated with each individual product. The lowest-cost provider of an individual item is displayed by default. However, if the user wishes to find an alternative provider, he or she can scroll through the pull-down menu until he or she finds a satisfactory provider. The same is true with the aggregate provider display area, when there is more than one aggregate provider. In the case of FIG. 8 however, there is only one available aggregate provider and, consequently, there is no pull-down menu of alternative providers.

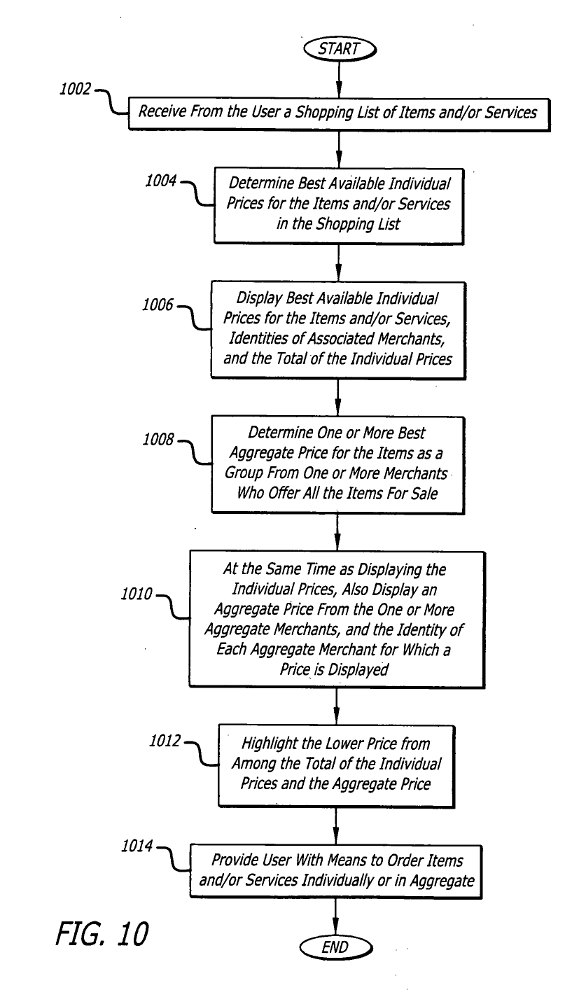

FIG. 10 reviews the steps in one embodiment of a method in accordance with the present invention. In Step 1002, the system receives from the user a shopping list of items and/or services. In Step 1004, the system determines the best available individual prices for the items and/or services in the shopping list. In Step 1006, the system displays the best available individual prices for the items and/or services. The identities of the associated merchants and the total of the individual prices is also displayed.

At Step 1008, the system determines the best aggregate price for the items purchased together as a group from a merchant that offers all the items for sale. The system may alternatively display several best aggregate prices from more than one merchant that offers all the items for sale. In Step 1010, at the same time as displaying the individual prices, the system also displays at least a best aggregate price from at least one aggregate merchant, along with the identity of each aggregate merchant for which a price is displayed.

Step 1012 is an optional step in which the system highlights the lower price from between the total of the individual prices and the aggregate price. That is, if the total price of ordering the items individually is lower than the total price of ordering the items together in aggregate, the system highlights the total price of the items ordered individually. In Step 1014, the user is provided with means to order items and/or services individually or in aggregate. This “means” is typically a link to the website of one or more merchants where the items may be purchased. In the case of a link to a provider of individual items or services, the link may be directly to the page on the merchant's website on which the item and/or service is described. In the case of a link to a provider of the items and/or services in aggregate, the link may be to a page listing all of the items, their respective prices, the shipping cost, and/or other information. It is understood, however, that the link may be to other pages of the respective sites.

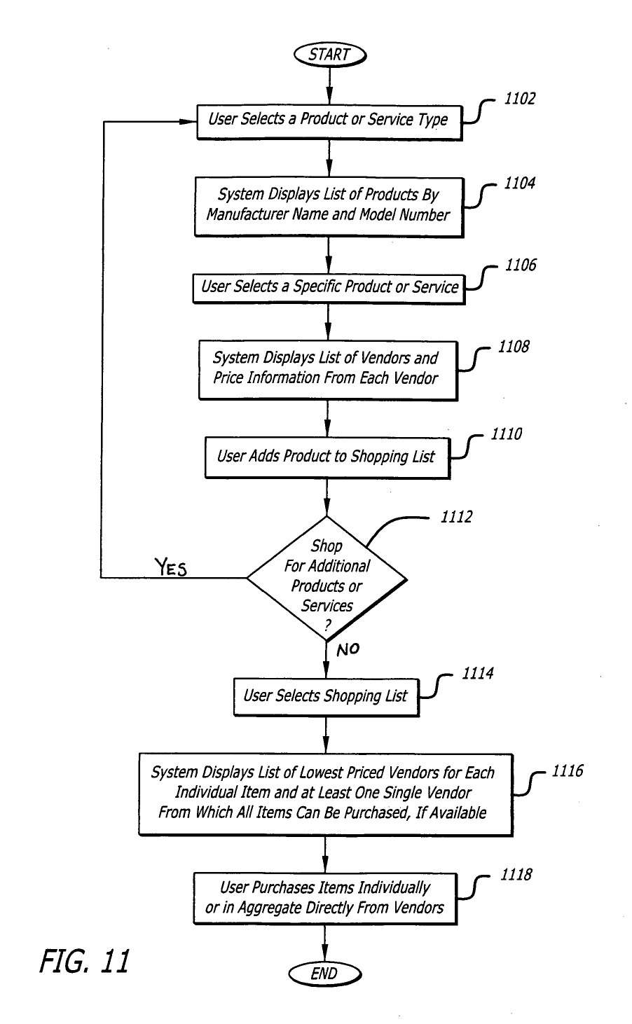

FIG. 11 is a flow chart illustrating an alternative method according to an embodiment of the invention. At Step 1102, the user selects an item or service type. At Step 1104, the system displays a list of products by manufacturer name and model number, among other optional information. At Step 1106, the user selects a specific product or service. At Step 1108, the system displays a list of vendors and price information from each vendor. At Step 1110, the user adds an item or service to the shopping list. At Step 1112, if the user wishes to continue shopping, he or she starts the process anew.

At Step 1114, the user has finished shopping and navigates to the shopping list. At Step 1116, the system displays a list of lowest priced vendors for each individual item, and at least one single vendor from which all items can be purchased, if such a vendor is available. The system also displays the total price of the items if bought separately and the total price of the items if bought in aggregate from a single merchant. At Step 1118, the user then purchases the items and/or services individually or in aggregate directly from one or more vendors.

Optionally, the system may allow the user to specify criteria for the merchants to be displayed in response to a particular item or shopping list. The criteria could include a maximum number of merchants, a minimum rating for the merchant, a minimum number of consumer reviews, or particular merchants from a predefined “favorite merchants” list. For example, the user could specify one or more, or any combination, of the following: that only the 10 merchants offering the lowest aggregate price be displayed; that three of the user's predefined favorite merchants (from whom the consumer may have had positive buying experiences in the past and whom the consumer therefore trusts) be displayed if they offer the product(s) specified, plus other merchants, up to a maximum of 10 total merchants; that no merchants be displayed who have not received an aggregate consumer rating of at least four stars out of five; and/or that no merchants be displayed who have not received at least 100 positive consumer reviews. An option may be provided for the user to modify the merchant selection criteria, i.e., to refine the search, after receiving the initial comparison shopping results.

Additionally, rather than identifying for each item on the list a specific product, the user may be allowed to identify a general product type or other parameters for one or more items on the list. For example, if a consumer is building his own computer, he may wish to specify by make and model a particular hard drive, internal memory, video card, etc. He may, however, wish to specify only the brand of the processor but not its speed, and may want an LCD monitor without specifying a make and model. The system would then suggest the available options within the designed product range(s).

As a further option, once the user has selected his items to purchase, instead of being required to click through to the vendor's site in order to actually order the items, the user is given the option to order the items directly from the comparison shopping website operator. In this embodiment after the user has decided from which merchant(s) he wishes to purchase the items, he may simply click on an “Order Now” or “Check Out” button by which he proceeds directly to checkout at the comparison shopping site. The site operator then contacts the merchant(s) and initiates the purchase(s) on the user's behalf. Still further, if a user chooses to order all of the items on his shopping list from a single merchant, the shopping site operator can send a message to the merchant indicating all of the items to be preloaded by the merchant into the user's shopping basket at the merchant's site. Such a message could take various forms as will be apparent to software programmers, and could include the use of a cookie placed on the user's computer by the shopping site operator and read at the merchant's website.

Considering now the process by which the system searches from among a variety of vendors to find the lowest individual and aggregate prices, methods for implementing comparative shopping sites are well-known in the art. One approach is to establish a database in which data pertaining to vendors, the products and/or services that they offer, price information, and other information is stored. The system then sorts through the database when conducting a search. In one arrangement, vendors directly contribute information to the database by providing data files, filling out online forms of information, or other methods that are known in the art. Alternative systems that will be known by those skilled in the art may also be implemented within the scope of the invention.

In the illustrative embodiment the system is implemented across a global information network such as the Internet, and using protocols including the world wide web and hypertext transfer protocol (http). The information to be displayed is viewed by the consumer using a program such as a commercially available browser program.

It will be appreciated that the term “present invention” as used herein should not be construed to mean that only a single invention having a single essential element or group of elements is presented. Similarly, it will also be appreciated that the term “present invention” encompasses a number of separate innovations which can each be considered separate inventions. Although the present invention has thus been described in detail with regard to the illustrative embodiment and illustrations thereof, it should be apparent to those skilled in the art that various adaptations and modifications of the present invention may be accomplished without departing from the spirit and the scope of the invention.

For example, in addition to merely displaying the total of the best individual prices and the best aggregate price and allowing the user to make a numerical comparison, the system may present a visual indicator to the user indicating which of the total prices is best. This visual indicator could be presented via larger text, bold text, blinking text, a blinking box around the lowest price, a yellow highlight box around the best price, a colored and/or flashing arrow containing the legend “Best Deal,” or some other visual indicator to quickly draw the user's attention to the best possible price for all of the items considered together.

Another alternative permits the user to click on a “View a Summary without Product Breakdown” option. The resulting screen shows only the aggregate sellers' total prices, and eliminates the detail of the individual item prices from the aggregate sellers. This is therefore a more compact way of viewing the comparison results.

In another approach, the system may include the capacity to directly purchase products from the system itself, rather than having to link to external sites of merchants. In this embodiment, the system could take the order from the user, then in turn transmit an order or orders for items and/or services to the merchant or merchants. This would save the user from the step of going onto one or more merchant's websites in order to actually purchase the items or services.

The present invention may be implemented by various methods. Those methods include, but are not limited to, email, instant messaging, web pages, pagers, telephones, facsimile, and text messages via pagers and cellular telephones. The present invention could be adapted for use with any or even all of those communication methods, as well as communication modes that have yet to be invented or popularized. Still further, it will be understood that the terms “article,” “product,” and “service” as used in the claims which follow can refer either to a single discrete article, product and/or service, or collectively to a set of separate and distinct articles, products and/or services.

Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A system for allowing a user to compare purchasing options comprising:
an input section which allows a user to specify a list of items for possible purchase;
a processing section for determining best available individual prices for the items if purchased separately from different merchants, and for determining a single aggregate price if the items are purchased together from a single merchant;
a first display section for displaying the best available individual prices; and
a second display section for displaying the single aggregate price.

2. The system of claim 1 wherein the prices include shipping.

3. The system of claim 1 wherein the prices include shipping and taxes.

4. The system of claim 1 wherein the best available individual prices and the single aggregate price are both displayed on a single Web page.

5. The system of claim claim 1 wherein the processing section further determines a plurality of best available aggregate prices from a respective plurality of merchants, and the second display section displays said plurality of best available aggregate prices and associated merchants.

6. The system of claim 1 wherein:
the first and second display sections are presented to a user on a single Web page;
the user can add items listed within the second display section to a virtual shopping cart by selecting each item, the selection of the item causing a new browser window to open displaying a page from the single merchant's web site; and
the user adds each item to a shopping cart by performing a single click at said single merchant's web page.

7. The system of claim 1 wherein:
the first and second display sections are presented to a user on a single Web page;
the user can add items listed within the second display section to a virtual shopping cart by selecting all items at once and adding them as a group to the shopping cart by performing a single click.

8. The system of claim 1 wherein:
at least the first display section includes information as to the availability of the item.

9. The system of claim 1 wherein:
at least one of said first and second display sections includes merchant rating information.

10. Computer readable media containing computer instructions capable of causing a computer to implement the system of claim 1.

11. A method of allowing shoppers to compare prices from different vendors comprising:
receiving from the user a list of items selected, said items defining a shopping list;
determining best available individual prices for said items from a first plurality of merchants;
displaying for the user said best available individual prices for said items and the merchants associated, respectively, with those individual prices, and a total of those individual prices;
determining at least one best available aggregate price for said items as a group from at least a first merchant who offers all of said items for sale, said first merchant defining a first aggregate merchant;
displaying for the user said at least one aggregate price;
whereby the user can directly see price differences between purchasing the items individually versus purchasing the items from said aggregate merchant, and thus decide whether he wishes to purchase the items individually from said different merchants or as a group from a common merchant.

12. The method of claim 11 further comprising:
displaying the identities of the merchants along with the associated best available prices; and
displaying the identity of said first aggregate merchant along with said aggregate price.

13. The method of claim 12 wherein said at least one aggregate price displayed and said at least one aggregate merchant associated therewith comprise a plurality of aggregate prices and associated aggregate merchants.

14. The method of claim 11 further comprising means for highlighting the lower of said individual price total and said best available aggregate price whereby a user receives a visual indicator of the best possible overall price for said list of items.

15. A system for allowing a user to compare purchasing options comprising:
means for allowing a user to specify a list of items for possible purchase;
means for determining best available individual prices for the items if purchased separately from different merchants, and means for determining a single aggregate price if the items are purchased together from a single merchant;
means for displaying the best available individual prices; and
means for displaying the single aggregate price.

16. A system of claim 15 wherein the system further comprises means for allowing a user to purchase a list of items either individually from one or more sources or in aggregate from a single source.

17. The system of claim 15 wherein the system includes means for allowing the user to evaluate a vendor of an item.

18. The system of claim 15 wherein the system further comprises means for allowing the user to determine the availability of an item from a vendor.

19. The system of claim 15 wherein the system further comprises means for providing the user with price information for an item from several different vendors.

20. The system of claim 15 wherein the system further comprises means for allowing the user to search for an item.
